(19) United States
(12) Patent Application Publication
(10) Pub. No.: US 2023/0186351 A1
(43) Pub. Date: Jun. 15, 2023

(54) Transformer Based Search Engine with Controlled Recall for Romanized Multilingual Corpus

(71) Applicant: Convosight Analytics Inc., New York, NY (US)

(72) Inventors: Tarun Kumar Dhamija, New York, NY (US); Tamanna Dhamija, New York, NY (US); Ram Dayal Goyal, Bangalore (IN); Subhodeep Dey, Kolkata (IN)

(73) Assignee: Convosight Analytics Inc, New York, NY (US)

(21) Appl. No.: 17/546,538

(22) Filed: Dec. 9, 2021

(51) Int. Cl. G06Q 30/02; G06F 40/295; G06F 40/284; G06F 40/247; G06F 3/04847

(52) U.S. Cl. CPC G06Q 30/0276; G06Q 30/0202; G06F 40/295; G06F 40/284; G06F 40/247; G06F 3/04847

(57) ABSTRACT

Described herein is a method and model system to improve the quality of search recall in the social media communication posts that often contains the local language words written in Romanized English script. A Deep Learning Transformer based model architecture and algorithm improves the search recall for a given English query. The model is trained to find named entities from post and queries, and these entities are compared to find the matching score using a specially designed model that takes into account the post's recency and its cleanliness score. The cleanliness score is obtained from a trained LSTM based model. The input English query is expanded to a set of equivalent queries by including contextually nearest words. The number of nearest words can be controlled using a slider mechanism.

### BACKGROUND

This invention in general relates to online communication, and specifically relates to analysis of social media posts.

Social media communities are a rich source of information for extracting valuable insights in terms of conversations and sentiments for campaign management for commercial brands and products. A search query is performed to fetch relevant social media posts from the vast pool of social media communications. The result of this search query is a list of relevant posts arranged in a decreasing order of relevance. For example, a business marketing manager of a brand conducts such a search to fetch relevant organic conversations corresponding to a general natural language search query. From the relevant results, a number of valuable statistical insights can be drawn for the benefit of business.

However, there are multiple challenges around extracting insight on brands from social media conversations, the primary being that a major chunk of conversations is in Romanized local languages i.e. Local language written using Roman English script. For example, consider the text conversation: “Nestle kaa dahi bahut achha hai” which is a Romanized Hindi version of the English sentence “Nestle's curd is very good”. On the contrary, the brand manager would be searching for the information in English structured query for example “Nestle curd”. This poses a first challenge to search engines because the search engine finds matches with only English words and does not match with their Romanized local language versions. Thus, the recall of results will be reduced drastically.

The second challenge is that there could be many synonyms or local versions of the same words which are contextually similar but are difficult to capture through a string match within search engine.

On the top of above two challenges, there are textual problems such as spelling mistakes etc. which make the recall further challenging.

### BRIEF DESCRIPTION OF FIGURES

FIG. 1 illustrates a method and system comprising a deep learning transformer based search engine with controlled recall for Romanized multilingual corpus.

FIG. 2 illustrates the application of a LSTM based Posts Cleanliness Score Computing model.

FIGS. 3A and 3B illustrate the detailed architecture of deep learning transformer based identification of named entities and similarities computation of post and query.

FIG. 4 illustrates the processing of raw posts.

FIG. 5 illustrates the process of query expansion.

FIG. 6 illustrates a slider control for selection of expansion factor for named entities.

FIG. 7 exemplarily illustrates the usage stage.

FIG. 8 illustrates computation of post recency score.

### SUMMARY

The above-mentioned unmet needs are addressed by a method and system comprising a deep learning transformer based search engine with controlled recall for Romanized multilingual corpus.

The method described herein includes the detection and translation of the Romanized Local Language of posts to English Language. A post and query matching algorithm is applied using a deep learning approach involving Transformer.

The first challenge is dealt with using the available language detection and translation tools, for example applying a Google Language Translation API, which is used to detect the language type and convert the text to an English structured text if the language of a sentence is not in English. Thus, all the posts will be available in English post this step.

Addressing the second challenge, expand the query to include more words which are contextually similar to the given words in the query. These expanded queries are used to achieve better recall after identification of named entities in posts and queries. For example, if the query is “soothing effect of johnson's cream”, then the query will be expanded to “calming effect of johnson's cream”, “calming effect of johnson's lotion”.

Train a deep learning transformer-based model to perform the following: (a) Predict named entities (NEs) in both the query stream of information and in the posts. These named entities are not the part of speech of the sentences but they are persona name, brand name, product or general-word. (b) Compute the similarity score between a post and a query based on the named entity, post cleanliness score, and recency of post.

Finally, a matching score is assigned to each post with respect to the given query. After receiving the matching score for all the posts for the given query, the posts are arranged in a decreasing order of this score.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system for providing a user with the most relevant posts for a user query applied to social media posts. The system also includes a processor; a memory containing instructions, when executed by the processor, configure the system to: preprocess said posts, may include: clean the posts by removing emoticons and accented characters, and expand hashtags; conduct English translation for Romanized local language terms; compute post recency score, where said recency score is calculated using the age of the post; train an LSTM based model for computing post cleanliness score; compute post cleanliness score using said trained LSTM based model; clustering of words of said English translation to group words with minimal spelling variations; store said English translated posts, said post recency score, and said post cleanliness score in a database; and store the historical user queries in said database. The system also includes train a deep learning transformer based model to compute the similarity matching score between posts and the query, may include; fetch said English translated posts, said post cleanliness score, said post recency score from the database, and said stored historical user queries; prepare training and validation data may include: annotate said named entities in said English translated posts and said historical user queries; annotate user applied matching score for supervision of query and posts combination. The system also includes divide said annotated English translated posts and said annotated historical user queries between training data and validation data; iteratively train said deep learning transformer based model to identify name entities within said posts and said queries in said training data and calculate the similarity score between said posts and query using a modified loss function that utilizes said post recency score and said post cleanliness score, conduct said iteration until a predefined level of accuracy is reached on said validation data. The system also includes use said trained deep learning transformer based model to determine said most relevant posts for said user query, may include; provide a user interface to accept the query entered by said user; predict named entities for the query using said trained deep learning transformer model; generate expanded queries from said named entities; fetch all the stored posts, apply said trained deep learning transformer model to compute a similarity matching score for the post corresponding to each of said expanded queries, and record the best matching score; sort the posts in decreasing order of best matching score for the given query; and present said sorted posts as said most relevant posts to said user. Other embodiments of this aspect include corresponding computer systems, apparatus, and computer programs recorded on one or more computer storage devices, each configured to perform the actions of the methods.

Implementations may include one or more of the following features. The system where said post cleanliness score is computed by a long short-term memory (LSTM) model, may include: fetch said English translated stored posts from said database; iteratively train a LSTM based post cleanliness score model to compute post cleanliness score; and apply said trained LSTM based post cleanliness score model to compute a sigmoid score, the exponent of said sigmoid score is returned as said post cleanliness score. Said deep learning transformer model further may include: a transformer encoder; a named entity recognition component; a Hadamard product per entity; and a query-post matching score component. Said transformer encoder: converts said query and said post's sentences to integers using a tokenizer text to sequences function, where each of said integers is a look-up to an embedding matrix that converts the integers to vectors; applies a scaling factor to said vectors of posts and query and create a first output; represents the position of each token within the post and query as a positional encoder vector and adds said positional encoder vectors to said first output, and thereafter generate a second output; passes said second output through a self-attention layer to create a third output; and passes said third output through a dense layer, and thereafter through a normalization layer and through further dense layers to finally create a fourth output predicting the named entity vectors. Said fourth output is applied to a dense layer with softmax function that predicts one or more of persona name, brand name, product, or general-word from the query and post(s). The Hadamard product component may include: from the said fourth output, computing an average of multiple instances of the said entity vectors of the query for each entity and thereafter generate average query entity vectors; computing the average of multiple instances of the said entity vectors of the post for each entity and thereafter generating average post entity vectors; and applying the Hadamard product to the said average query entity vectors and average post entity vectors per entity and thereafter generating the fifth output. Said fifth output is concatenated with said post recency score and said post cleanliness score and passed through dense layers to compute the similarity matching score by applying a modified loss function. Said preparation of training and validation data may include: applying a baseline approach, may include the steps of: collecting queries from historical search data of said user(s), and for each said query: fetching the corresponding top predetermined number of relevant posts based on jaccard similarity of the tokens of the query and the tokens of the posts and annotating them as 1′; randomly picking said predetermined number of posts which have 0 matches of the tokens of the query and the post, and annotating them as 0′; and applying an embedding approach, may include the steps of: creating embedding vectors on the posts, and thereby storing the embedding vectors; collecting queries from the historical search data, and for each query, fetch the embedding vectors for each word/token in it, similarly fetch the embedding vector for each word/token in the posts; take the average vector of the embedding vectors of the query, and similarly take the average vector of the embedding vectors of the posts; find top predetermined number of nearest posts based on cosine similarity of the averaged query vector and the averaged post vector and annotate them as 1′; and find the predetermined number of farthest posts and annotate them as 0′. Training the said deep learning transformer based model may include; collecting said annotated training and validation data; fetching said computed post cleanliness score, and post recency score; iteratively performing the following steps on the training data to reach a sufficient accuracy level on the validation data, the steps may include: applying the post and query in their corresponding arms of said transformer encoder; applying all the transformations of each layer of said deep learning transformer based model from input through, named entity extraction, Hadamard product and similarity score; to reach the final outcome score; and updating all the weights based on the modified loss function using the standard back propagation algorithm. Said step of training the LSTM based post cleanliness score model may include: fetching said English translated stored posts; annotating each token of the posts as valid or not valid, and where the output of each post is 1 when the quality of the post is characterized by structured grammar, meaningful tokens, optimal number of words; and 0 if the posts are unstructured, unstructured abbreviations, slangs, and improper grammatical structure; converting tokens of posts to integers using tokenizer text to sequences; passing said integers through an embedding layer; feeding output of said embedding layer to an LSTM layer; feeding each hidden state of said LSTM layer into a dense layer to predict the outcome as valid, or not valid; and passing the hidden state at the last time step of the LSTM to a dense layer to predict the post cleanliness score; where the output of said model is a sigmoid output, the exponential of said sigmoid output is the post cleanliness score. Said step of creating expanded queries further may include: identify all named entities within said query, where said named entity(s) is one of persona name, brand name, product, or a general word; determine embedding of said named entities, where said embedding is a numeric vector representation of named entity(s); provide the user, a slider to select an expansion factor k for the named entities, and thereafter creating expanded entities using a nearest neighbor algorithm using said expansion factor k; identify and filter out the irrelevant named entities based on edit distance; determine the combination of said expanded entities based on said selected expansion factor, and generating new expanded queries. The system may include the step of selecting the expansion factor for each said named entity in the query using a slider, and for each entity's embedding vector select expansion factor k for the nearest neighbors algorithm. Predetermined default value is provided for the expansion factor, and the user has an option to save the choice and give it a name for a particular case, and retrieve it for later use. Implementations of the described techniques may include hardware, a method or process, or computer software on a computer-accessible medium.

One general aspect includes a method for providing a user with the most relevant posts for a user query applied to social media posts preprocessing said posts, where the preprocessing further may include: cleaning the posts by removing emoticons and accented characters, and expand hashtags; conducting English translation for Romanized local language terms; computing post recency score, where said recency is calculated using the age of the post; training LSTM based model for computing post cleanliness score; computing post cleanliness score using said trained LSTM based model; clustering of words of said English translation to group words with minimal spelling variations; storing said English translated posts, said post recency score and said post cleanliness score in a database; and storing the historical user queries in said database. The method also includes training a deep learning transformer based model to compute the similarity matching score between posts and the query, may include; fetching said English translated posts, said post cleanliness score, said post recency score from the database and said stored historical user queries; preparing training and validation data may include: annotating said named entities in said English translated posts and said historical user queries; annotating user applied matching score for supervision of query and posts combination. The method also includes dividing said annotated English translated posts and said annotated historical user queries between training data and validation data; iteratively training said deep learning transformer based model to identify name entities within said posts and said queries in said training data and calculate the similarity score between said posts and query using a modified loss function that utilizes said post recency score and said post cleanliness score, conduct said iteration until a predefined level of accuracy is reached on said validation data. The method also includes applying said trained deep learning transformer based model to determine said most relevant posts for said user query, may include; providing a user interface to accept the query entered by said user; predicting named entities for the query using said trained deep learning transformer model; generating expanded queries from said named entities; fetching all the stored posts, apply said trained deep learning transformer model to compute a similarity matching score for the post corresponding to each of said expanded queries, and record the best matching score; sorting the posts in decreasing order of best matching score for the given query; and presenting said sorted posts as said most relevant posts to said user. Other embodiments of this aspect include corresponding computer systems, apparatus, and computer programs recorded on one or more computer storage devices, each configured to perform the actions of the methods.

Implementations may include one or more of the following features. The method where said post cleanliness score is computed by a long short-term memory (LSTM) model, may include: fetching said English translated stored posts from said database; iteratively training a LSTM based post cleanliness score model to compute post cleanliness score; and applying said trained LSTM based post cleanliness score model to compute a sigmoid score, the exponent of said sigmoid score is returned as said post cleanliness score. Said deep learning transformer model further may include: a transformer encoder; a named entity recognition component; a Hadamard product per entity; and a query-post matching score component. Said transformer encoder: converts said query and said post's sentences to integers using a tokenizer text to sequences function, where each of said integers is a look-up to an embedding matrix that converts the integers to vectors; applies a scaling factor to said vectors of posts and query and create a first output; represents the position of each token within the post and query as a positional encoder vector and adds said positional encoder vectors to said first output, and thereafter generate a second output; passes said second output through a self-attention layer to create a third output; and passes said third output through a dense layer, and thereafter through a normalization layer and through further dense layers to finally create a fourth output predicting the named entity vectors. Said fourth output is applied to a dense layer with softmax function that predicts one or more of persona name, brand name, product or general word from the query and post(s). The method may include: from the said fourth output, computing average of multiple instances of the said entity vectors of the query for each entity and thereafter generating average query entity vectors; computing the average of multiple instances of the said entity vectors of the post for each entity and thereafter generating average post entity vectors; and applying the Hadamard product to said average query entity vectors and average post entity vectors per entity and thereafter generate the fifth output. Implementations of the described techniques may include hardware, a method or process, or computer software on a computer-accessible medium.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structures and devices are shown in block diagram form only in order to avoid obscuring the invention.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

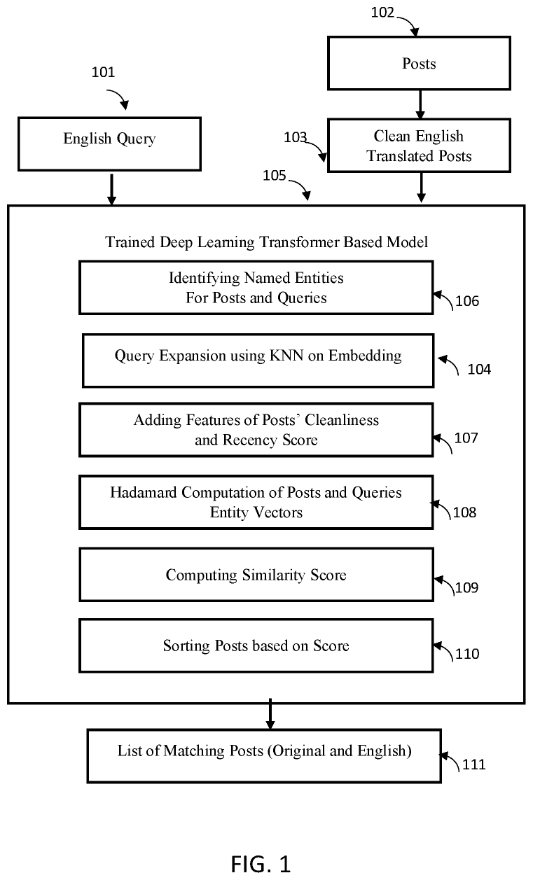

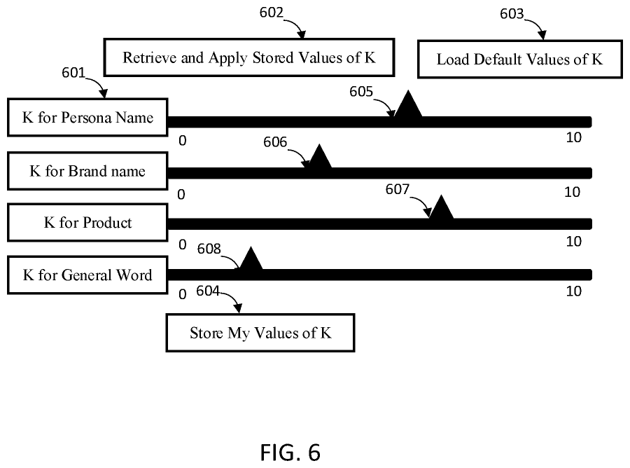

FIG. 1 illustrates a method and system comprising a deep learning transformer based search engine with controlled recall for Romanized multilingual corpus. The user inputs an English query 101, and the query 101 is passed through the deep learning transformer 105 and predicts the named entities. The user selects K 605, 606, 607, 608 (FIG. 6) for each named entity 106 found for the query, and finds the K nearest neighbors 104 of each of the entities in the corresponding embedding vector space.

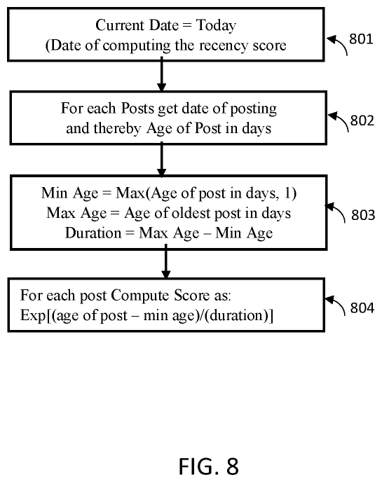

The step of fetching all the preprocessed and cleaned posts 102, 103 comprises the steps of (a) General cleaning such as removal of punctuation etc. (b) Finding English translation 103 using available resource such as Google API, and storing in a database. (c) Determining a post cleanliness score 204 using a trained model (d) Periodically computing recency score indicating the age of posts (FIG. 8) (e) Finding the defined named entities, i.e. one or more of persona name, brand name, product, or general-word 106.

The step of using the trained deep learning transformer based model to compute the similarity score thereby comprises the steps of (a) Identifying the named entities in the posts and the queries 106 (b) Performing the Hadamard product of corresponding averaged entity vectors of each query and post combination 108 (c) Fetching the post cleanliness score and recency score 107 (d) Computing the similarity Matching Score for a given post corresponding to each expanded query and taking the max score as the similarity match score 109 for the post in consideration. (e) For the original given query, sort the posts in decreasing order of similarity matching score 110. Display the sorted results 111.

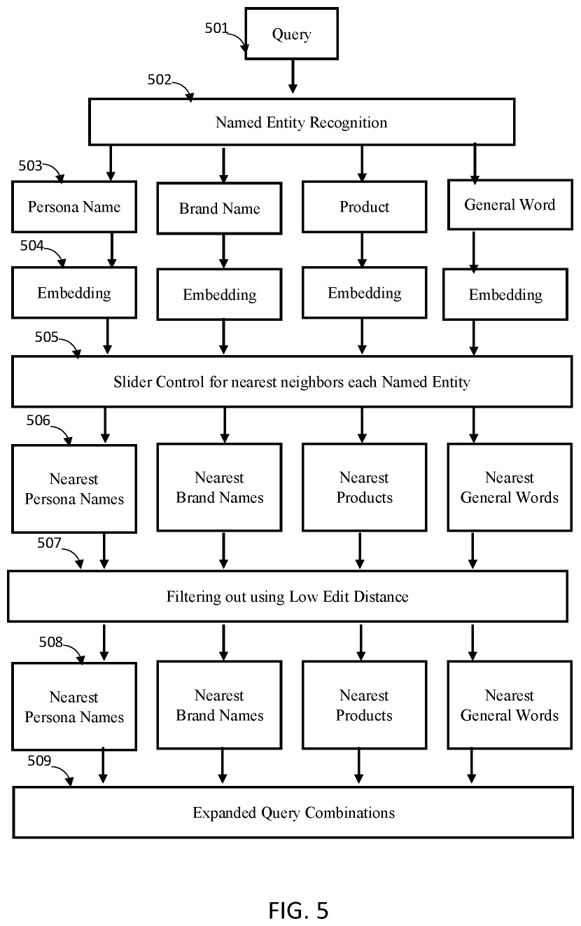

FIG. 5 illustrates the process of query 501 expansion. Identify the named entities 502 in the query using a trained transformer based model for recognizing named entities. Utilize the following four named entities 503: persona name, brand name, product or general word. Find the embeddings 504 vectors for the same. FIG. 6 illustrates a slider control for the selection of expansion factor. The user selects the expansion factor (number of nearest neighbors) using slider control 505 for each entity. For each entity's embedding vector we find K nearest neighbors using KNN algorithm in the same vector space. Also, provide a default value for the expansion factor. The user also has an option to save the choice and give it a name for a particular case, and retrieve it for later use. In order to prevent spurious neighbors, filter out a few nearest neighbors 507 if they are too far based on the edit distance of the original words. Thereafter, take a combination of variation of named entities 508 and generate a set of new equivalent queries 509.

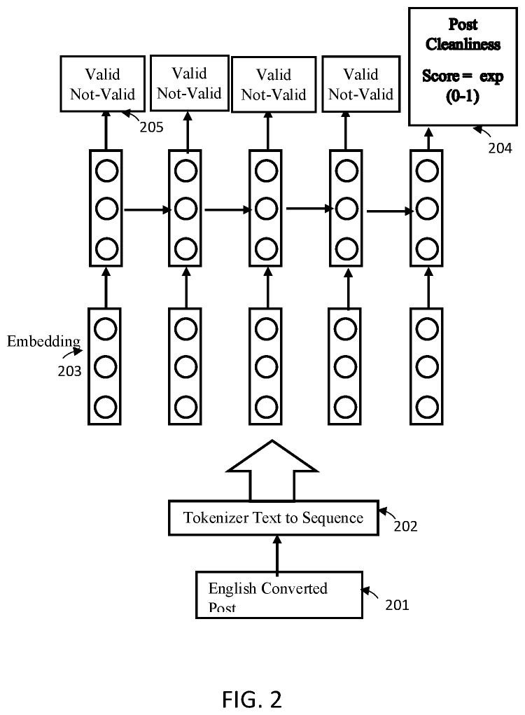

FIG. 2 illustrates the application of a LSTM based Posts Cleanliness Score Computing model. The objective of this Post Cleanliness Score module is to create the post cleanliness score as a feature to accommodate in the main model. This influences the search results in accordance with consideration given to the quality of the posts. The hypothesis is that bad quality posts, even if they have the right matches, will not give valuable information. Thus, give weightage or importance to the posts which are written in a more structured and grammatically correct manner than others.

The original post is converted to English Language 201. This English translated version post is tokenized 202 to a token sequence. Corresponding to each token, generate embedding 203 vectors using embedding layers, for example, a Keras embedding layer. Apply a LSTM layer with each token signified as a valid/not-valid token, and the final result is a sigmoid score (between 0-1), the exponent of which is the post cleanliness score 204.

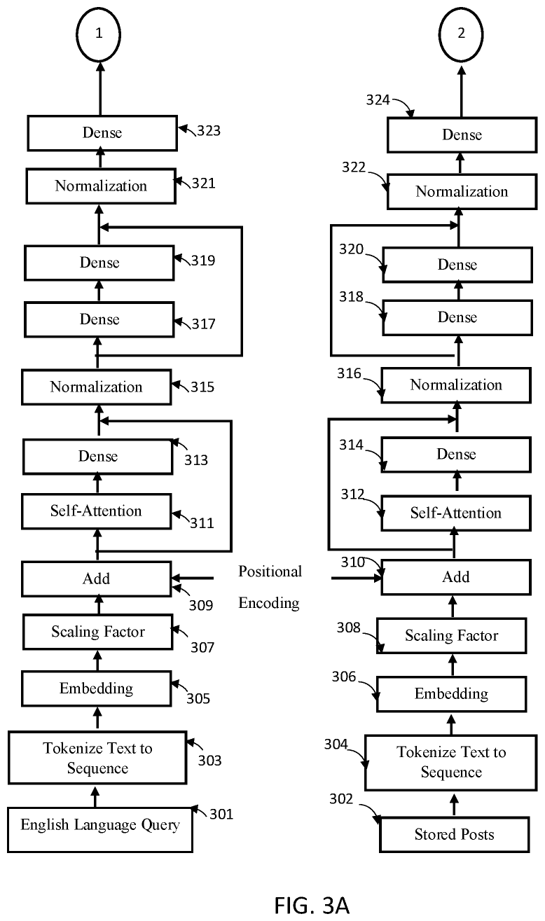

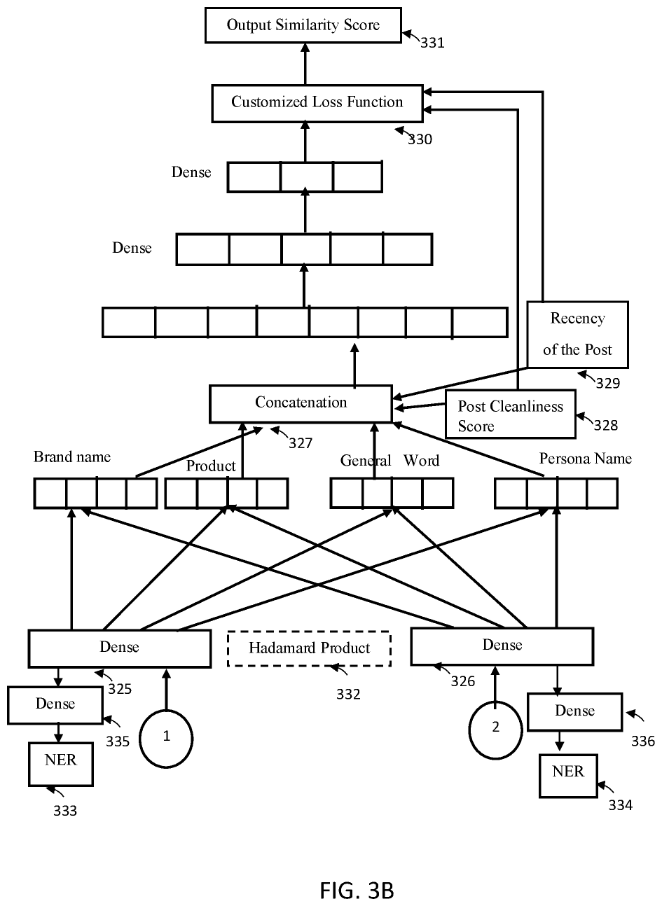

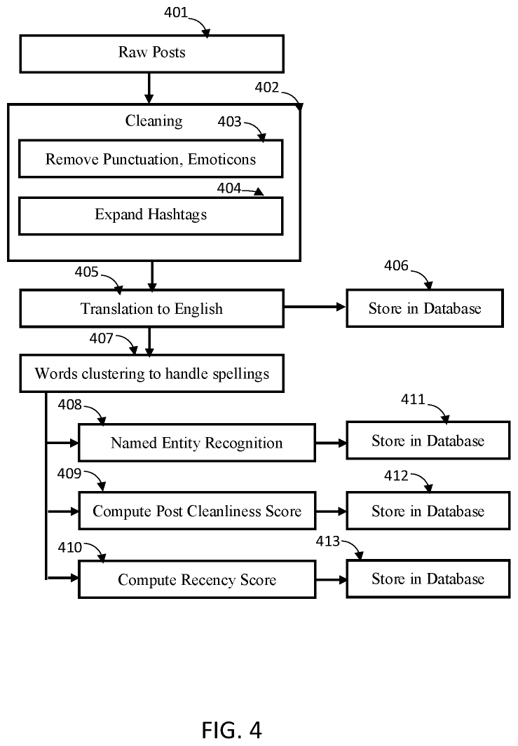

FIG. 4 illustrates the pre-processing of the posts before they are used to serve the user for their queries. Original raw posts 401 are cleaned 402 by removing punctuations, Emoticons 403, and expanding hashtag 404. Thereafter, the posts are translated to English 405 using some available translators such as Google Language Translators. The translated version is stored in database 406 for quick retrieval at a later stage. In the translated posts, using a DBSCAN algorithm on words using edit distance, find clusters of words which have very minor difference in their spellings and replace them with their representative 407. From the resultant posts, extract named entities 408 (brand name, product, persona name, general-word) using the pretrained deep learning transformer based model of FIGS. 3A, 3B. These named entities are stored in database 411 for their retrieval while using the system. For each post, compute the Post Cleanliness Score 409 and store the same in database 412. Periodically, compute the post recency score of each post 410, and store the same in database 413 for its retrieval at usage stage.

FIG. 8 illustrates the computation of Post Recency Score. The current date is set as the date of computing the score 801. For each post, fetch the date of its posting 802. The age of each post is computed as number of days passed between the posting date and current date. The Min Age is the number of days past posting date of most recent post. If the Min Age is less than 1 day, then it is set to 1 day. The duration is computed as the number of days passed between the oldest and the most recent posts 803. For each post, the Recency Score is computed as exp[(age of post−min age)/(duration)] 804.

FIGS. 3A and 3B illustrates the detailed architecture of deep learning transformer based identification of named entities and computation of similarities of posts and queries.

The named entity recognition component, within the deep learning transformer based model, determines named entities from posts as well as queries. Subsequently, these named entity vectors from posts and queries are sent to a Post-Query Similarity Score Matching Model. The named entity recognition component also incorporates post cleanliness score and the post's recency score, while computing the final matching score as illustrated in FIG. 3A and FIG. 3B.

The deep learning transformer-based model comprises the following components: The transformer, the Named Entity Extractor (NER), Hadamard product per entity, and a query-post matching score model.

The transformer encoder is described herein. Apply two parallel arms of encoders as shown in the FIG. 3A. One encoder is applied to a query 301 and the other encoder is applied to a post 302.

The query 301 and the post (cleaned English translated post) sentences are converted to integers using the tokenizer 303, 304 text to sequences function, which also includes the step of padding/truncating the sentences to a fixed length.

Each of the integers is a look-up to the embedding 305, 306 matrix which converts the integers to a vector. These vectors are scaled 307, 308 by a constant (scaling factor). The positional encoder layer is a layer which represents the positions of the tokens. The positional encoder vector is then added to the encoder output that was received as an output after blocks 307 and 308. Pass the above vectors through a self-attention 311, 312 layer. The self-attention layer is applied on the output after block 309, 310. The attention layer's output is passed through a dense layer 313, 314. Add the output of step 309 to the output of block 313. Add the output of step 310 to the output of block 314. The output is then passed through a Normalization layer 315, 316. Pass the output of the previous layers through dense layers 317, 319, 318, 320 and then add the residual connection of the output of block 315 and 316. Pass the vectors through a normalization layer 321, 322. Add a couple of dense layers 323, 324, 325, 326 and then another one 335, 336 to predict the named entities out of the four entities that were predefined.

The named entity recognition (NER) component 333, 334 is described herein. As illustrated in FIG. 3B, the named entity extractor is a dense 335, 336 layer with Softmax function to predict the outcome of the abstract vectors extracted by the Transformer. The objective of the named entity recognition component is to find the entities persona name, brand name, product or general-word from the query and post. The entities are used to match the query and the post instead of using all combinations of words to avoid spurious correlations and reduce computing time.

The Hadamard product 332, illustrated in FIG. 3B, is described herein. Once the entities have been extracted from the post and the query, take the Hadamard product 332 of the corresponding brand vector of the query and the post, and similarly take the Hadamard product 332 for the corresponding other entity vectors of the query and the post.

If the query has more than one brand vector, then it is averaged out, similarly if the post has more than one brand vector, it is averaged out. The Hadamard product 332 is calculated on these averaged vectors. A similar process is applied for products, general word and the persona name for the post and query.

The vectors of the product, brand name, general word and persona name are concatenated 327 along with the Post Recency Score 329 and Post Cleanliness Score 328. These vectors become the input to the similarity score 331 computing component.

The post and query similarity score computing component is described herein. The input to the model consists of concatenated 327 vectors of Hadamard products of persona name, brand name, product or general-word vectors from the post and query along with the Post Cleanliness Score 329 and Post Recency Score 328. This input is passed through a couple of dense layers to predict the score (sigmoid output). A modified Loss Function 330 is applied as shown below:

$$\frac{1}{n} {\sum }_{k = 0}^{n} [ {λ}_{j} * \{ {y}_{{actual}_{k}} * log ( {y}_{{pred}_{k}} ) + ( 1 - {y}_{{actual}_{k}} ) * log ( 1 - {y}_{{pred}_{k}} ) \} ]$$

where,
k is query, post pair index
λj is the harmonic mean of the Post Recency Score and the
Reciprocal of Post Cleanliness Score of the jth post;
y_{actual}_{ₖ} is target output of k^{th} query-post pair,
y_{pred}_{ₖ} is obtained output of k^{th} query-post pair.

Described herein are the methods of training the before mentioned models.

The method of training the LSTM based post cleanliness score model is described herein.

The data for the model is prepared by annotating each token of the (translated version of the Romanized language) post as valid or not valid 205. The output of each post is 1 when the quality of the post is good, characterized by structured grammar, meaningful tokens, optimal number of words, and the output of each post is 0 if the posts are unstructured, unstructured abbreviations, slangs, and improper grammatical structure.

The preprocessing steps for the LSTM based post cleanliness score model involves the stripping off of the emoticons 403, the hashtag expansions 404, and the accented characters removal.

The posts will be converted to integers using tokenizer text to sequences 202. This list of integers is then passed through an embedding layer. The output of the embedding layer 203 is then fed to an LSTM. Each hidden state of the LSTM time step is then fed into a dense layer to predict the outcome of valid, not valid 205. The hidden state at the last time step is then passed through a dense layer to predict the post cleanliness score 204. The output of this model is the sigmoid output, the exponential of which will be used as a post cleanliness score 204.

The post recency score 409 of all posts at a particular snap shot is calculated as shown in FIG. 8 and described above.

The training process for the Deep Learning Transformer Based Model is described herein.

The data annotation for named entity recognition is described below. The objective is to prepare the data in such manner that the model can be trained to learn custom entities through the queries and the posts.

The custom entities defined are persona name, brand name, product or general-word. The objective of creating these custom entities is to calculate similarity scores based on corresponding name tokens, brand tokens, product tokens and the general word tokens of query and post. This avoids the creation of spurious cosine similarities and reduces computational time.

An annotation framework is applied to annotate the entities for the post and the queries, wherein supervision for each token is assigned. The supervision is performed on English translated version of posts and queries, and not on the Romanized local languages.

The data annotation for post, query similarity score model is described below. In order to prepare the training data for the post matching algorithm, apply the following steps.

The baseline approach comprises the step of collecting queries from historical search data, and for each query fetch the corresponding top 10 relevant posts based on Jaccard similarity (intersection over union) and annotate them as ‘1’. Randomly pick 10 posts which have 0 matches of the tokens. Annotate them as ‘0’.

The embedding approach comprises of the step to create word2vec on the posts, and thereby storing the embedding vectors. Collect queries from the historical search data, and for each query, fetch the embedding vectors for each word/token in it, similarly fetch the embedding vector for each word/token in the post. Take the average vector of the embedding vectors of the query, and similarly take the average vector of the embedding vectors of the post. Find top 10 nearest posts based on cosine similarity of query vector and post vector. Annotate them as ‘1’. Find the lowest 10 (in terms of cosine similarities) posts and annotate them as ‘0’.

The data preprocessing steps are described herein. Once the posts are translated to English, and the post cleanliness score has been calculated, perform the following steps on translated posts. The emoticons are removed and stripped off, the hashtags are expanded, the accented characters are removed and stripped off. The source language is expected to have a wide variety of tokens with minor spelling changes. Apply a DBSCAN algorithm with edit distance as the distance metric to condense the different representations of the same word. Tokens/words with a very low edit distance will be clubbed together in one cluster, the parameters of dbscan algorithm will be chosen in such a way that very similar tokens fall in the same cluster, and there would be a representative meaningful word for that cluster which will be assigned to all the other words of the cluster. This condensation will be analyzed to recheck the mapping, and this mapping will be updated in a pre-decided time interval.

The training process for the deep learning transformer is described as follows. Collect the annotated data instances (Query, Post, Target). Additionally, annotate named entity for posts and queries. Fetch the computed Post Cleanliness Score, Post Recency Score also. Exemplarily, divide the data in 70% (Training set) 30% (validation set) ratio. Train the model until a sufficient level of accuracy is achieved as described below.

Apply the post and query in their corresponding arms of encoder. For the corresponding embedding layers, transform the query, and post to vectors. After passing all the transformations of each layer from input through, named entity extraction, Hadamard product and similarity score; reach the final outcome score. All the weights are updated based on the customized loss function using the standard back propagation algorithm. The training process is repeated for many epochs until sufficient accuracy is achieved on the validation set.

The overall implementation consists of the training stage and the usage stage.

Train the LSTM based Post Cleanliness Score Model which will be used to find the cleanliness score of a post. Train the Deep Learning Transformer based model to recognize the named entity (persona name, brand name, product or general-word) from the post and query, and thereby find the similarity score of the post and query. The named entities, the recency score and the post cleanliness score of the posts are stored in the database 411, 412, 413 so that these can be fetched directly during run time. Periodically update the recency score 410 for each post in the database 413. For all the latest posts for which recency score 410 has not been computed, keep the highest score.

Described herein is an exemplification of the usage stage.

System is used by typing a query in the input 501, for Eg: ‘BMW 320 long term reliability’

Named Entities (persona name, brand name, product, general word) are found 502 using NER model, for Eg: BMW (brand name) 320 (product), long (general word), term (general word), reliability (general word).

Find Nearest Neighbors for each entity using slider to select ‘K’ 505. The user can either use default values for each entity or can reload their own stored values, for Eg: ‘Bimmer 320 long term reliability’, ‘Bimmer 320 long term issues’, ‘Bimmer 320 long term concerns’. It is to be noted that BMW token was expanded within the brand name vector space, and the general word terms were expanded within the general word space.

Nearest neighbors 506 are filtered/sorted 507 out based on edit distance For Eg: BMW and Mercedes may share very similar embeddings, however when we want to expand the query 509, we still want to retain the search space for BMW related tokens.

New equivalent queries are generated using the combination of nearest neighbors.

For each post Dj, following operations are performed:
(a) Retrieve Named Entities for Dj from stored database—For example the post: ‘my <general word> bmw <brand name> has <general word> been <general word> serving <general word> me <general word> well <general word> for <general word> the <general word> last <general word> 7 <general word> years <general word>’
(b) Get corresponding Embedding 504 of named entities for example: ‘my’ will have a n dimensional embedding

Retrieve Post Cleanliness Score—204 for example: ‘my <general word> bmw <brand name> has <general word> been <general word> serving <general word> me <general word> well <general word> for <general word> the <general word> last <general word> 7 <general word> years <general word>’ has a Post Cleanliness Score of e^{0.92}=2.5

Retrieve Post Recency Score 413 e^{0.2}=1.22

Find named entities and corresponding vectors for the Hadamard Product 332, so for example in the above case, the query: ‘BMW <brand name> 320 <product>, long <general word>, term <general word>, reliability <general word>’, and the post ‘my <general word> bmw <brand name> has <general word> been <general word> serving <general word> me <general word> well <general word> for <general word> the <general word> last <general word> 7 <general word> years <general word>’, the general word vectors of the query will be averaged out and the general word vectors of the post will be averaged out, and a Hadamard product 332 will be calculated, the operations are similarly performed for the brand name, persona name and product.

Thereby, for each expanded Query Qi perform the following:
a. Find named entities and corresponding vectors for Hadamard Product 332
b. Conduct a Hadamard Product 332 of corresponding named entity vectors of post's and the query's after averaging out.
c. Get Final Similarity Matching Score 331 for pair (Qi, Dj) as shown in FIG. 3b.

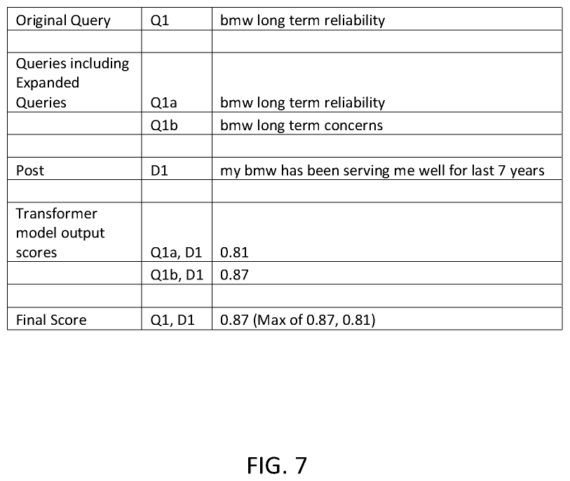

Take max score for Dj—represent the best matching with expanded queries., for example, in our case document (my <general word> bmw <brand name> has <general word> been <general word> serving <general word> me <general word> well <general word> for <general word> the <general word> last <general word> 7 <general word> years <general word>), when matched with query (BMW <brand name> 320 <product>, long <general word>, term <general word>, reliability <general word>) has a score of 0.81, and with query (Bimmer <brand name> 320 <product name> long <general word> term <general word> concerns <general word>) has a score of 0.87, so the representative score of the query document pair is taken as 0.87. The example is illustrated in FIG. 7

Sort the documents based on decreasing order of score

Show the sorted documents (English Translated Posts) along with original (raw posts)

The processing steps described above may be implemented as modules or models. As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. After reading this description, it will become apparent to a person skilled in the relevant art how to implement the invention using other computing modules or architectures.

In general, the modules/routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

Modules might be implemented using a general-purpose or special-purpose processing engine such as, for example, a microprocessor, controller, or other control logic. In the illustrated example, the modules could be connected to a bus, although any communication medium can be used to facilitate interaction with other components of computing modules or to communicate externally.

The computing server might also include one or more memory modules, simply referred to herein as main memory. For example, preferably random access memory (RAM) or other dynamic memory, might be used for storing information and instructions to be executed by processor. Main memory might also be used for storing temporary variables or other intermediate

information during execution of instructions to be executed by a processor. Computing module might likewise include a read only memory (“ROM”) or other static storage device coupled to bus for storing static information and instructions for processor.

The database module might include, for example, a media drive and a storage unit interface. The media drive might include a drive or other mechanism to support fixed or removable storage media. For example, a hard disk drive, a floppy disk drive, a magnetic tape drive, an optical disk drive, a CD, DVD or Blu-ray drive (R or RW), or other removable or fixed media drive might be provided. Accordingly, storage media might include, for example, a hard disk, a floppy disk, magnetic tape, cartridge, optical disk, a CD, DVD or Blu-ray, or other fixed or removable medium that is read by, written to or accessed by media drive. As these examples illustrate, the storage media can include a computer usable storage medium having stored therein computer software or data.

In alternative embodiments, the database modules might include other similar instrumentalities for allowing computer programs or other instructions or data to be loaded into the computing module. Such instrumentalities might include, for example, a fixed or removable storage unit and an interface. Examples of such storage units and interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system for providing a user with the most relevant posts for a user query applied to social media posts, comprising:
a processor;
a memory containing instructions, when executed by the processor, configure the system to:
preprocess said posts, further comprising:
clean the posts by removing emoticons and accented characters, and expand hashtags;
conduct English translation for Romanized local language terms;
compute post recency score, wherein said recency score is calculated using age of the post;
train an LSTM based model for computing post cleanliness score;
compute post cleanliness score using said trained LSTM based model;
clustering of words of said English translation to group words with minimal spelling variations;
store said English translated posts, said post recency score, and said post cleanliness score in a database; and
store the historical user queries in said database;
train a Deep Learning Transformer Based model to compute the similarity matching score between posts and the query, comprising:
fetch said English translated posts, said post cleanliness score, said post recency score from the database, and said stored historical user queries;
prepare training and validation data further comprising:
annotate said named entities in said English translated posts and said historical user queries;
annotate user applied matching score for supervision of query and posts combination;
divide said annotated English translated posts and said annotated historical user queries between training data and validation data;
iteratively train said Deep Learning Transformer Based model to identify name entities within said posts and said queries in said training data and calculate the similarity score between said posts and query using a modified loss function that utilizes said post recency score and said post cleanliness score, conduct said iteration until a predefined level of accuracy is reached on said validation data; and
use said trained Deep Learning Transformer based model to determine said most relevant posts for said user query, comprising:
provide a user interface to accept the query entered by said user;
predict named entities for the query using said trained deep learning transformer model;
generate expanded queries from said named entities;
fetch all the stored posts, apply said trained deep learning transformer model to compute a similarity matching score for the post corresponding to each of said expanded queries, and record the best matching score;
sort the posts in decreasing order of best matching score for the given query; and
present said sorted posts as said most relevant posts to said user.

2. The system of claim 1, wherein said post cleanliness score is computed by a Long Short-Term Memory (LSTM) model, comprising:
fetch said English translated stored posts from said database;
iteratively train a LSTM based post cleanliness score model to compute post cleanliness score; and
apply said trained LSTM based post cleanliness score model to compute a sigmoid score, the exponent of said sigmoid score is returned as said post cleanliness score.

3. The system of claim 1, wherein said deep learning transformer model further comprises:
a transformer encoder;
a named entity recognition component;
a Hadamard product per entity; and
a query-post matching score component.

4. The system of claim 3, wherein said transformer encoder:
converts said query and said post's sentences to integers using a tokenizer text to sequences function, wherein each of said integers is a look-up to an embedding matrix that converts the integers to vectors;
applies a scaling factor to said vectors of posts and query and create a first output;
represents the position of each token within the post and query as a positional encoder vector and adds said positional encoder vectors to said first output, and thereafter generate a second output;
passes said second output through a self-attention layer to create a third output; and
passes said third output through a dense layer, and thereafter through a normalization layer and through further dense layers to finally create a fourth output predicting the named entity vectors.

5. The system of claim 3, wherein said fourth output is applied to a dense layer with softmax function that predicts one or more of persona name, brand name, product, or general-word from the query and post(s).

6. The system of claim 3, wherein the Hadamard product component comprises:
from the said fourth output, computing an average of multiple instances of the said entity vectors of the query for each entity and thereafter generate average query entity vectors;
computing the average of multiple instances of the said entity vectors of the post for each entity and thereafter generating average post entity vectors; and
applying the Hadamard product to the said average query entity vectors and average post entity vectors per entity and thereafter generating the fifth output.

7. The system of claim 3, wherein said fifth output is concatenated with said post recency score and said post cleanliness score and passed through dense layers to compute the similarity matching score by applying a modified loss function.

8. The system of claim 1, wherein said preparation of training and validation data comprises:
applying a baseline approach, further comprising the steps of:
collecting queries from historical search data of said user(s), and for each said query:
fetching the corresponding top predetermined number of relevant posts based on Jaccard similarity of the tokens of the query and the tokens of the posts and annotating them as ‘1’;
randomly picking said predetermined number of posts which have 0 matches of the tokens of the query and the post, and annotating them as ‘0’; and
applying an embedding approach, further comprising the steps of:
creating embedding vectors on the posts, and thereby storing the embedding vectors;
collecting queries from the historical search data, and for each query, fetch the embedding vectors for each word/token in it, similarly fetch the embedding vector for each word/token in the posts;
take the average vector of the embedding vectors of the query, and similarly take the average vector of the embedding vectors of the posts;
find top predetermined number of nearest posts based on cosine similarity of the averaged query vector and the averaged post vector and annotate them as ‘1’; and
find the predetermined number of farthest posts and annotate them as ‘0’.

9. The system of claim 1, wherein training the said Deep Learning Transformer based model comprises;
collecting said annotated training and validation data;
fetching said computed post cleanliness score, and post recency score;
iteratively performing the following steps on the training data to reach a sufficient accuracy level on the validation data, the steps comprising:
applying the post and query in their corresponding arms of said transformer encoder;
applying all the transformations of each layer of said deep learning transformer based model from input through, named entity extraction, Hadamard product and similarity score; to reach the final outcome score; and
updating all the weights based on the modified loss function using the standard back propagation algorithm.

10. The system of claim 1, wherein said modified loss function comprises:
$$\frac{1}{n} {\sum }_{k = 0}^{n} [ {λ}_{j} * \{ {y}_{{actual}_{k}} * log ( {y}_{{pred}_{k}} ) + ( 1 - {y}_{{actual}_{k}} ) * log ( 1 - {y}_{{pred}_{k}} ) \} ]$$

11. The system of claim 1, wherein said step of training the LSTM Based Post Cleanliness Score Model comprises:
fetching said English translated stored posts;
annotating each token of the posts as valid or not valid, and wherein the output of each post is 1 when the quality of the post is characterized by structured grammar, meaningful tokens, optimal number of words; and 0 if the posts are unstructured, unstructured abbreviations, slangs, and improper grammatical structure;
converting tokens of posts to integers using tokenizer text to sequences;
passing said integers through an embedding layer;
feeding output of said embedding layer to an LSTM layer;
feeding each hidden state of said LSTM layer into a dense layer to predict the outcome as valid, or not valid; and
passing the hidden state at the last time step of the LSTM to a dense layer to predict the post cleanliness score, wherein the output of said model is a sigmoid output and the exponential of said sigmoid output is the post cleanliness score.

12. The system of claim 1, wherein said step of creating expanded queries further comprises:
identify all named entities within said query, wherein said named entity(s) is one of persona name, brand name, product, or a general word;
determine embedding of said named entities, wherein said embedding is a numeric vector representation of named entity(s);
provide the user, a slider to select an expansion factor K for the named entities, and thereafter creating expanded entities using a nearest neighbor algorithm using said expansion factor K;
identify and filter out the irrelevant named entities based on edit distance; and
determine the combination of said expanded entities based on said selected expansion factor, and generating new expanded queries.

13. The system of claim 12, comprising the step of selecting the expansion factor for each said named entity in the query using a slider, and for each entity's embedding vector select expansion factor K for the nearest neighbors algorithm.

14. The system of claim 13, wherein predetermined default value is provided for the expansion factor, and the user has an option to save the choice and give it a name for a particular case, and retrieve it for later use.

15. A method for providing a user with the most relevant posts for a user query applied to social media posts, comprising:
preprocessing said posts, wherein the preprocessing further comprises:
cleaning the posts by removing emoticons and accented characters, and expand hashtags;
conducting English translation for Romanized local language terms;
computing post recency score, wherein said recency is calculated using age of the post;
training LSTM based model for computing post cleanliness score;
computing post cleanliness score using said trained LSTM based model;
clustering of words of said English translation to group words with minimal spelling variations;
storing said English translated posts, said post recency score and said post cleanliness score in a database; and
storing the historical user queries in said database;
training a Deep Learning Transformer Based model to compute the similarity matching score between posts and the query, comprising:
fetching said English translated posts, said post cleanliness score, said post recency score from the database and said stored historical user queries;
preparing training and validation data further comprising:
annotating said named entities in said English translated posts and said historical user queries;
annotating user applied matching score for supervision of query and posts combination; and
dividing said annotated English translated posts and said annotated historical user queries between training data and validation data;
iteratively training said Deep Learning Transformer Based model to identify name entities within said posts and said queries in said training data and calculate the similarity score between said posts and query using a modified loss function that utilizes said post recency score and said post cleanliness score, conduct said iteration until a predefined level of accuracy is reached on said validation data;
applying said trained Deep Learning Transformer based model to determine said most relevant posts for said user query, comprising:
providing a user interface to accept the query entered by said user;
predicting named entities for the query using said trained deep learning transformer model;
generating expanded queries from said named entities;
fetching all the stored posts, apply said trained deep learning transformer model to compute a similarity matching score for the post corresponding to each of said expanded queries, and record the best matching score;
sorting the posts in decreasing order of best matching score for the given query; and
presenting said sorted posts as said most relevant posts to said user.

16. The method of claim 15, wherein said post cleanliness score is computed by a Long Short-Term Memory (LSTM) model, comprising:
fetching said English translated stored posts from said database;
iteratively training a LSTM based post cleanliness score model to compute post cleanliness score; and
applying said trained LSTM based post cleanliness score model to compute a sigmoid score, the exponent of said sigmoid score is returned as said post cleanliness score.

17. The method of claim 15, wherein said deep learning transformer model further comprises:
a transformer encoder;
a named entity recognition component;
a Hadamard product per entity; and
a query-post matching score component.

18. The method of claim 17, wherein said transformer encoder:
converts said query and said post's sentences to integers using a tokenizer text to sequences function, wherein each of said integers is a look-up to an embedding matrix that converts the integers to vectors;
applies a scaling factor to said vectors of posts and query and create a first output;
represents the position of each token within the post and query as a positional encoder vector and adds said positional encoder vectors to said first output, and thereafter generate a second output;
passes said second output through a self-attention layer to create a third output; and
passes said third output through a dense layer, and thereafter through a normalization layer and through further dense layers to finally create a fourth output predicting the named entity vectors.

19. The method of claim 17, wherein said fourth output is applied to a dense layer with softmax function that predicts one or more of persona name, brand name, product or general word from the query and post(s).

20. The method of claim 17, further comprising:
from the said fourth output, computing average of multiple instances of the said entity vectors of the query for each entity and thereafter generating average query entity vectors;
computing the average of multiple instances of the said entity vectors of the post for each entity and thereafter generating average post entity vectors; and
applying the Hadamard product to said average query entity vectors and average post entity vectors per entity and thereafter generate the fifth output.
